(19) United States
(12) Patent Application Publication
(10) Pub. No.: US 2026/0184625 A1
(43) Pub. Date: Jul. 2, 2026

(54) METHOD OF FORMING LITHIUM-FREE GLASS ARTICLES HAVING IMPROVED COMPRESSIVE STRESS AND REDUCED WARP

(71) Applicant: CORNING INCORPORATED, CORNING, NY (US)

(72) Inventors: Ozgur Gulbiten, Painted Post, NY (US); Atul Kumar, Horseheads, NY (US); Qiang Zhang, Hefei (CN); Zheming Zheng, Horseheads, NY (US)

(21) Appl. No.: 19/407,518

(22) Filed: Dec. 3, 2025

(30) Foreign Application Priority Data
Dec. 30, 2024 (CN) 202411969307.2

(51) Int. Cl. C03C 21/00; C03C 3/091; C03C 23/00

(52) U.S. Cl. CPC C03C 21/002; C03C 3/091; C03C 23/007

(57) ABSTRACT

A method of forming a lithium-free glass article includes thermally treating the glass article to impart a fictive temperature and ion exchanging the thermally treated glass article. The thermal treatment includes heating the glass article to a hold temperature from 130° C. below to 20° C. above an annealing point of the glass article; holding the glass article at the hold temperature for a hold period; cooling the glass article at a first cooling rate from the hold temperature to an intermediate temperature; and cooling the glass article at a second cooling rate from the intermediate temperature to room temperature. The ion exchanged glass article includes a compressive stress greater than or equal to 900 MPa, as measured for an article having a thickness of 1.1 mm; and a warp less than or equal to 0.3 mm, as measured for an article having a length less than 200 mm.

### CROSS-REFERENCE TO RELATED APPLICATIONS

This application claims the benefit of priority under 35 U.S.C. § 119 of Chinese Patent Application Serial No. 202411969307.2 filed Dec. 30, 2024, the content of which is incorporated herein by reference in its entirety.

### FIELD

The present specification generally relates to methods of forming glass articles and, in particular, to methods of forming lithium-free glass articles having improved compressive stress and reduced warp.

### TECHNICAL BACKGROUND

In many applications, glasses may be chemically strengthened by ion exchange, which forms a compressive surface layer in the glass. For example, glasses used in automotive interior articles may have a relatively high compressive stress to meet automotive safety requirement, such as head form impact tests. Li₂O may be included in the glass articles to enable ion exchangeability. However, lithium prices are increasing due to, among other things, the rapid adoption of electric vehicles. Moreover, conventional glass articles may not have both improved compressive stress and reduced warp.

Therefore, a continuing need exists for methods of forming lithium-free glass articles having improved compressive stress and reduced warp.

### SUMMARY

According to a first aspect A1, a method of forming a lithium-free glass article comprises: thermally treating the lithium-free glass article to impart a fictive temperature, the thermal treatment comprising: heating the lithium-free glass article to a hold temperature greater than or equal to 130° C. below and less than or equal to 20° C. above an annealing point of the lithium-free glass article; holding the lithium-free glass article at the hold temperature for a hold period; and cooling the lithium-free glass article at a first cooling rate from the hold temperature to an intermediate temperature; cooling the lithium-free glass article at a second cooling rate from the intermediate temperature to room temperature; and ion exchanging the thermally treated lithium-free glass article, wherein the ion exchanged lithium-free glass article comprises: a compressive stress greater than or equal to 900 MPa, as measured for an article having a thickness of 1.1 mm; and a warp less than or equal to 0.3 mm, as measured for an article having a length less than 200 mm.

A second aspect A2 includes the method of the first aspect A1, wherein the fictive temperature is greater than or equal to 550° C. and less than or equal to 700° C.

A third aspect A3 includes the method of the first aspect A1 or the second aspect A2, wherein the hold period is greater than or equal to 0.05 minutes and less than or equal to 24 hours.

A fourth aspect A4 includes the method of the third aspect A3, wherein the hold period is greater than or equal to 0.25 minutes and less than or equal to 6 hours.

A fifth aspect A5 includes the method of any one of the first through fourth aspects A1-A4, wherein the lithium-free glass article is heated to the hold temperature at a heating rate greater than or equal to 3° C./min and less than or equal to 20° C./min.

A sixth aspect A6 includes the method of any one of the first through fifth aspects A1-A5, wherein the hold temperature is greater than or equal to 110° C. below and less than or equal to 5° C. above an annealing point of the lithium-free glass article.

A seventh aspect A7 includes the method of any one of the first through sixth aspects A1-A6, wherein the hold temperature is greater than or equal to 500° C. and less than or equal to 650° C.

An eighth aspect A8 includes the method of any one of the first through seventh aspects A1-A7, wherein the first cooling rate is greater than or equal to 0.2° C./min and less than or equal to 4° C./min.

A ninth aspect A9 includes the method of any one of the first through eighth aspects A1-A8, wherein the intermediate temperature is greater than or equal to 300° C. and less than or equal to 530° C.

A tenth aspect A10 includes the method of any one of the first through ninth aspects A1-A9, wherein the second cooling rate is greater than or equal to 20° C./min and less than or equal to 120° C./min.

An eleventh aspect A11 includes the method of any one of the first through tenth aspects A1-A10, wherein the ion exchanging the thermally treated lithium-free glass article comprises strengthening the thermally treated lithium-free glass article in an ion exchange bath at a temperature greater than or equal to 380° C. and less than or equal to 500° C. for a time period greater than or equal to 1 hour and less than or equal to 20 hours.

A twelfth aspect A12 includes the method of the eleventh aspect A11, wherein the ion exchange bath comprises greater than or equal to 90 wt % and less than or equal to 100 wt % KNO₃ and greater than or equal to 0 wt % and less than or equal to 10 wt % NaNO₃.

A thirteenth aspect A13 includes the method of any one of the first through twelfth aspects A1-A12, wherein the ion exchanged lithium-free glass article comprises a compressive stress greater than or equal to 1000 MPa, as measured for an article having a thickness of 1.1 mm.

A fourteenth aspect A14 includes the method of any one of the first through thirteenth aspects A1-A13, wherein the ion exchanged lithium-free glass article comprises a warp less than or equal to 0.2 mm, as measured for an article having a length less than 200 mm.

A fifteenth aspect A15 includes the method of any one of the first through fourteenth aspects A1-A14, wherein the ion exchanged lithium-free glass article comprises a depth of layer greater than or equal to 35 μm, as measured for an article having a thickness of 1.1 mm.

A sixteenth aspect A16 includes the method of any one of the first through fifteenth aspects A1-A15, wherein the ion exchanged lithium-free glass article comprises an automotive interior article.

A seventeenth aspect A17 includes the method of any one of the first through sixteenth aspects A1-A16, wherein the lithium-free glass article comprises an alkali aluminosilicate glass or an alkali aluminoborosilicate glass.

An eighteenth aspect A18 includes the method of any one of the first through seventeenth aspects A1-A17, wherein the lithium-free glass article comprises: greater than or equal to 50 wt % and less than or equal to 70 wt % SiO₂; greater than or equal to 0 wt % and less than or equal to 10 wt % B₂O₃; greater than or equal to 10 wt % and less than or equal to 30 wt % Al₂O₃; greater than or equal to 2 wt % and less than or equal to 20 wt % Na₂O; greater than or equal to 0 wt % and less than or equal to 1 wt % SnO₂; and greater than or equal to 0 wt % and less than or equal to 5 wt % MgO.

A nineteenth aspect A19 includes the method of any one of the first through eighteenth aspects A1-A18, wherein the lithium-free glass article comprises a thickness greater than or equal to 0.2 mm and less than or equal to 2 mm.

A twentieth aspect A20 includes the method of any one of the first through nineteenth aspects A1-A19, wherein the thermally treating the lithium-free glass article comprises holding the lithium-free glass article in a cassette during thermal treatment.

Additional features and advantages of the methods of forming methods of forming lithium-free glass articles described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a flow chart of a method of forming a lithium-free glass article, according to one or more embodiments described herein;

FIG. 2 is a plot of thermal treatment (x-axis: time; y-axis: temperature), according to one or more embodiments described herein;

FIG. 3 is a plot of fictive temperature T_{f} measured before ion exchange (x-axis; in ° C.) versus fictive temperature modeling (y-axis; in ° C.) of sample articles, according to one or more embodiments described herein;

FIG. 4 is a plot of modeled fictive temperature T_{f} (y-axis; in ° C.) versus hold temperature (x-axis; in ° C.), according to one or more embodiments described herein;

FIG. 5 is a plot of deformation indicator (y-axis) versus hold temperature (x-axis; in ° C.), according to one or more embodiments described herein;

FIG. 6 is a plot of compressive stress CS (y-axis; in μm) versus fictive temperature T_{f} (x-axis; in ° C.) of glass articles, according to one or more embodiments described herein;

FIG. 7 is a plot of depth of layer DOL (y-axis; in μm) versus fictive temperature T_{f} (x-axis; in ° C.) of glass articles, according to one or more embodiments described herein;

FIG. 8 is a graph of the warp of glass articles subjected to various hold temperatures and hold periods, according to one or more embodiments described herein;

FIG. 9 is a graph of the warp of glass articles considering subjected to various cooling rates, according to one or more embodiments described herein;

FIG. 10 is a graph of the warp of glass articles having different article shapes, according to one or more embodiments described herein;

FIG. 11 is a graph of the warp of glass articles subjected to tilting, according to one or more embodiment described herein;

FIG. 12 are photographs of cassettes holding glass articles, according to one or more embodiments described herein; and

FIG. 13 is a graph of the warp of glass articles held in various cassettes, according to one or more embodiments described herein.

### DETAILED DESCRIPTION

Reference will now be made in detail to various embodiments of methods of forming lithium-free glass articles having improved compressive stress and reduced warp. According to embodiments, a method of forming a lithium-free glass article includes thermally treating the lithium-free glass article to impart a fictive temperature and ion exchanging the thermally treated lithium-free glass article. The thermal treatment may include heating the lithium-free glass article to a hold temperature greater than or equal to 130° C. below and less than or equal to 20° C. above an annealing point of the lithium-free glass article; holding the lithium-free glass article at the hold temperature for a hold period; cooling the lithium-free glass article at a first cooling rate from the hold temperature to an intermediate temperature; cooling the lithium-free glass article at a second cooling rate from the intermediate temperature to room temperature; and ion exchanging the thermally treated lithium-free glass article, wherein the ion exchanged lithium-free glass article may include a compressive stress greater than or equal to 900 MPa, as measured for an article having a thickness of 1.1 mm; and a warp less than or equal to 0.3 mm, as measured for an article having a length less than 200 mm.

Various embodiments of methods of forming lithium-free glass articles will be described herein with specific reference to the appended drawings.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

In the embodiments of the lithium-free glass article described herein, the amounts of constituent components (e.g., SiO₂, Al₂O₃, and the like) are specified in weight percent (wt %) on an oxide basis, unless otherwise specified.

The term “substantially free,” when used to describe the amount and/or absence of a particular constituent component in a lithium-free glass article, means that the constituent component is not intentionally added to the lithium-free glass article. However, the lithium-free glass article may contain traces of the constituent component as a contaminant or tramp in amounts of less than 0.05 weight percent (wt %).

The terms “0 mol %” and “free,” when used to describe the amount and/or absence of a particular constituent component in the lithium-free glass article, means that the constituent component is not present in lithium-free glass article, unless otherwise noted.

The term “lithium-free,” when used to describe the glass articles herein, means that the glass article is free or substantially free of lithium.

The term “fictive temperature,” as used herein, refers to the temperature at which at which the structural state of a glass would be in equilibrium were it heated or cooled very rapidly to that temperature. The fictive temperature is described in “Relation Between Inelastic Deformability and Thermal Expansion of Glass in its Annealing Range” by Arthur Q. Tool (Journal of the American Ceramic Society, vol. 29(9), pp. 240-253 (1946)): “The physicochemical condition or state of a glass is reasonably well known only when both the actual temperature and that other temperature at which the glass would be in equilibrium, if heated or cooled very rapidly to it, are known. This latter temperature has been termed the ‘equilibrium or fictive temperature’ of the glass.” In this context, “actual temperature” means whatever the glass is experiencing now (e.g., ambient, ion exchange temperature, etc.) and the fictive temperature is the last temperature at which the glass was in equilibrium.

Fictive temperature was measured using the method described in Guo, X.; Potuzak, M.; Mauro, J. C.; Allan, D. C.; Kiczenski, T. J.; Yue, Y. Unified approach for determining the enthalpic fictive temperature of glasses with arbitrary thermal history. Journal of Non-Crystalline Solids 2011, 357 (16), 3230, which is incorporated by reference herein in its entirety. Specifically, the fictive temperature was measured and calculated using a calorimetric enthalpy matching method using the thermal history dependence of the heat capacity in the glass transition range. The temperature-dependent heat capacity of the samples was measured utilizing a differential scanning calorimeter. Samples were prepared in the disc form and each sample was measured in Pt crucibles by scanning at 20° C./min heating rates for both the first scan, which is the “as is” thermal history, and the second scan, which is consecutively started after cooling the glass from the supercooled liquid to room temperature at a 20° C./min rate. The enthalpic fictive temperature of the samples was calculated by the analysis of the temperature-dependent configurational specific heat capacity using the unified enthalpy matching method. The calculation of the configurational heat capacity assumes that the vibrational heat capacity follows the same temperature-dependent polynomial functional form through the glass transition. Due to the enthalpic overshoots and undershoots in the glass transition range when the fictive temperature is significantly different than glass transition temperature, the second heating scan was used to calculate the vibrational heat capacity and extrapolated to the supercooled liquid region above the transition. The configurational heat capacity was calculated by subtracting the vibrational heat capacity from the total heat capacity.

The term “annealing point,” as used herein, refers to the temperature at which the viscosity of the glass composition is 1×10^{13.18} poise as measured in accordance with ASTM C598.

The term “room temperature,” as used herein, refers to 25° C.

Temperatures, heating rates, and cooling rates provided herein with respect to thermal treatment refer to the temperatures and rates of the furnace within which the lithium-free glass article is thermally treated.

Surface compressive stress is measured with a surface stress meter (FSM) such as commercially available instruments such as the FSM-6000, manufactured by Orihara Industrial Co., Ltd. (Japan). Surface stress measurements rely upon the measurement of the stress optical coefficient (SOC), which is related to the birefringence of the glass article. SOC, in turn, is measured according to Procedure C (Glass Disc Method) described in ASTM standard C770-16, entitled “Standard Test Method for Measurement of Glass Stress-Optical Coefficient,” the contents of which are incorporated herein by reference in their entirety. The values reported for surface compressive stress (CS) herein refer to the peak surface compressive stress, unless otherwise indicated.

According to the convention normally used in the art, compression or compressive stress (CS) is expressed as a negative (i.e., <0) stress and tension or tensile stress is expressed as a positive (i.e., >0) stress. Throughout this description, however, CS is expressed as a positive or absolute value (i.e., as recited herein, CS=|CS|).

As used herein, “depth of layer” (DOL) refers to the depth within a glass article at which an ion of metal oxide diffuses into the glass article where the concentration of the ion reaches a minimum value. DOL may be measured using electron probe microanalysis (EPMA).

As used herein, “warp,” is a metric to characterize the flatness of a generally planar sheet. That is, the distance (or deviation) of a plurality of points on a surface of the sheet is determined with respect to a reference plane, and the deviation in distance from the reference represents the deviation of the sheet's shape from a true plane—the “warp” of the sheet. The maximum warp may be used as a measure of the shape of the sheet (e.g., flatness of the sheet). The warp values given herein are measured using a feeler gauge.

As described herein, glasses used in automotive interior articles may be ion exchanged to have a relatively high compressive stress to meet automotive safety requirements, such as head form impact tests. Li₂O may be included in the glass articles to enable ion exchangeability. However, lithium prices are increasing due to, among other things, the rapid adoption of electric vehicles. Moreover, conventional glass articles may not have both improved compressive stress and reduced warp.

Disclosed herein are methods of forming lithium-free glass articles which mitigate the aforementioned problems. Specifically, the methods of forming a lithium-free glass article as described herein comprise thermally treating the lithium-free glass article to impart a fictive temperature. A relatively low fictive temperature correlates to a relatively high compressive stress (e.g., greater than or equal to 900 MPa, as measured for an article having a thickness of 1.1 mm). As such, imparting a reduced fictive temperature via the thermal treatment described herein helps to achieve an improved compressive stress. Additionally, a relatively high compressive stress generally correlates to increased warp. However, the thermal treatment described herein achieves a reduced warp (e.g., less than or equal to 0.3 mm, as measured for an article having a length less than 200 mm) while also achieving the improved compressive stress.

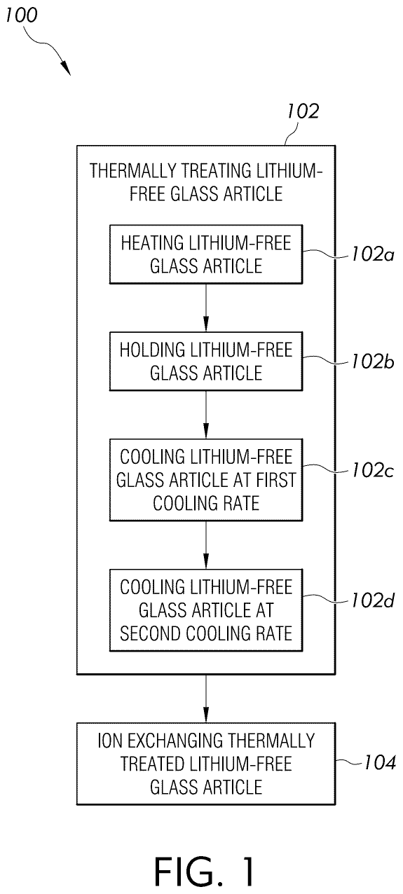

Referring now to FIG. 1, a method of forming a lithium-free glass article is shown at 100. Generally, the method 100 includes thermally treating the lithium-free glass article (block 102) and ion exchanging the thermally treated lithium-free glass article (block 104).

The method 100 begins at block 102 with thermally treating the lithium-free glass article to impart a fictive temperature. Reducing the fictive temperature creates a shrinkage or compaction of the glass structure, thereby densifying the glass. When the densified glass is subjected to ion exchange, the glass exhibits a relatively low amount of stress relaxation, thereby improving the compressive stress (e.g., greater than or equal to 900 MPa, as measured for an article having a thickness of 1.1 mm) of the resulting ion exchanged glass. The thermal treatment described herein also achieves a reduced warp (e.g., less than or equal to 0.3 mm, as measured for an article having a length less than 200 mm).

In embodiments, the fictive temperature of the lithium-free glass article, after thermal treatment, may be greater than or equal to 550° C. and less than or equal to 700° C. In embodiments, the fictive temperature of the lithium-free glass article, after thermal treatment, may be greater than or equal to 550° C., greater than or equal to 575° C., or even greater than or equal to 600° C. In embodiments, the fictive temperature of the lithium-free glass article, after thermal treatment, may be less than or equal to 700° C., less than or equal to 675° C., less than or equal to 650° C., or even less than or equal to 600° C. In embodiments, the fictive temperature of the lithium-free glass article, after thermal treatment, may be greater than or equal to 550° C. and less than or equal to 700° C., greater than or equal to 550° C. and less than or equal to 675° C., greater than or equal to 550° C. and less than or equal to 650° C., greater than or equal to 550° C. and less than or equal to 625° C., greater than or equal to 575° C. and less than or equal to 700° C., greater than or equal to 575° C. and less than or equal to 675° C., greater than or equal to 575° C. and less than or equal to 650° C., greater than or equal to 575° C. and less than or equal to 625° C., greater than or equal to 600° C. and less than or equal to 700° C., greater than or equal to 600° C. and less than or equal to 675° C., greater than or equal to 600° C. and less than or equal to 650° C., or even greater than or equal to 600° C. and less than or equal to 625° C., or any and all sub-ranges formed from any of these endpoints.

The glass articles described herein are lithium-free. In embodiments, the lithium-free glass article may be an alkali aluminosilicate glass or an alkali aluminoborosilicate glass. In embodiments, the lithium-free glass article may further comprise alkaline earth metals. In embodiments, by way of example and not limitation, the lithium-free glass article may comprise greater than or equal to 50 wt % and less than or equal to 70 wt % SiO₂; greater than or equal to 0 wt % and less than or equal to 10 wt % B₂O₃; greater than or equal to 10 wt % and less than or equal to 30 wt % Al₂O₃; greater than or equal to 2 wt % and less than or equal to 20 wt % Na₂O; greater than or equal to 0 wt % and less than or equal to 1 wt % SnO₂; and greater than or equal to 0 wt % and less than or equal to 5 wt % MgO. In embodiments, by way of example and not limitation, the lithium-free glass article may comprise greater than or equal to 57 wt % and less than or equal to 65 wt % SiO₂; greater than or equal to 2 wt % and less than or equal to 5 wt % B₂O₃; greater than or equal to 15 wt % and less than or equal to 20 wt % Al₂O₃; greater than or equal to 10 wt % and less than or equal to 15 wt % Na₂O; greater than or equal to 0.1 wt % and less than or equal to 0.5 wt % SnO₂; and greater than or equal to 0.5 wt % and less than or equal to 3 wt % MgO.

In embodiments, the lithium-free glass article may comprise a thickness greater than or equal to 0.2 mm and less than or equal to 2 mm. In embodiments, the lithium-free glass article may comprise a thickness greater than or equal to 0.2 mm, greater than or equal to 0.4 mm, greater than or equal to 0.6 mm, greater than or equal to 0.8 mm, or even greater than or equal to 1 mm. In embodiments, the lithium-free glass article may comprise a thickness less than or equal to 2 mm or even less than or equal to 1.5 mm. In embodiments, the lithium-free glass article may comprise a thickness greater than or equal to 0.2 mm and less than or equal to 2 mm, greater than or equal to 0.2 mm and less than or equal to 1.5 mm, greater than or equal to 0.4 mm and less than or equal to 2 mm, greater than or equal to 0.4 mm and less than or equal to 1.5 mm, greater than or equal to 0.6 mm and less than or equal to 2 mm, greater than or equal to 0.6 mm and less than or equal to 1.5 mm, greater than or equal to 0.8 mm and less than or equal to 2 mm, greater than or equal to 0.8 mm and less than or equal to 1.5 mm, greater than or equal to 1 mm and less than or equal to 2 mm, or even greater than or equal to 1 mm and less than or equal to 1.5 mm, or any and all sub-ranges formed from any of these endpoints.

Referring again to FIG. 1, the thermal treatment of block 102 may comprise block 102a with heating the lithium-free glass article to a hold temperature greater than or equal to 130° C. below and less than or equal to 20° C. above an annealing point of the lithium-free glass article, block 102b with holding the lithium-free glass article at the hold temperature for a hold period, block 102c with cooling the lithium-free glass article at a first cooling rate from the hold temperature to the intermediate temperature, and block 102d with cooling the lithium-free glass article at a second cooling rate from the intermediate temperature to room temperature.

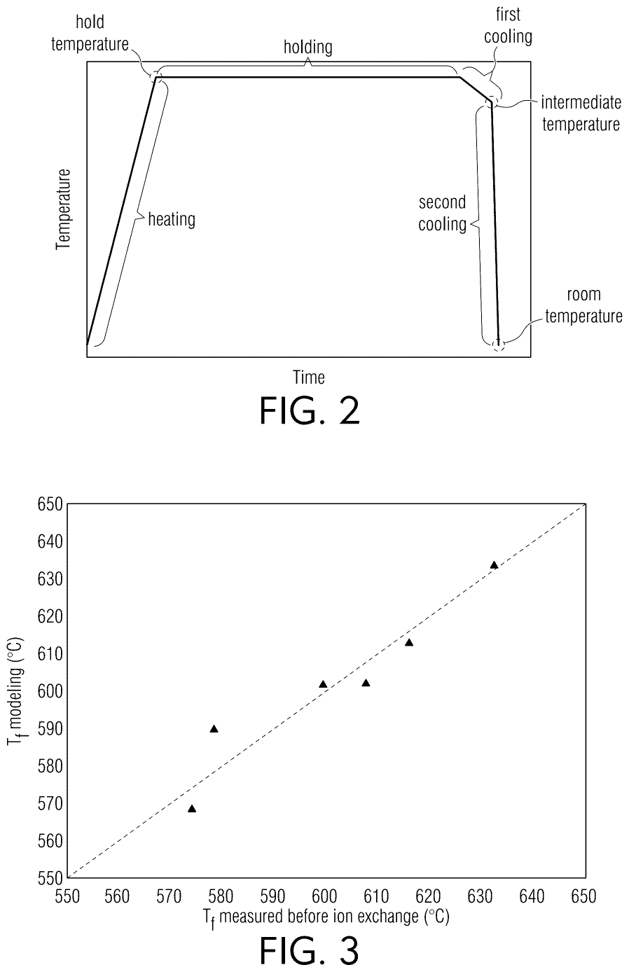

Referring now to FIG. 2, an example thermal treatment profile is shown. The thermal treatment profile includes heating the lithium-free glass article to a hold temperature greater than or equal to 130° C. below and less than or equal to 20° C. above an annealing point of the lithium-free glass article (block 102a of FIG. 1). Relatively greater hold temperatures may impart a relatively greater warp to the resulting ion exchanged lithium-free glass article. As such, in embodiments, it may be desirable to limit the hold temperature to achieve a desired warp (e.g., a warp less than or equal to 0.3 mm, as measured for an article having a length less than 200 mm).

In embodiments, the hold temperature may be greater than or equal to 130° C. below and less than or equal to 20° C. above an annealing point of the lithium-free glass article. In embodiments, the hold temperature may be greater than or equal to 110° C. below and less than or equal to 5° C. above an annealing point of the lithium-free glass article. In embodiments, the hold temperature may be greater than or equal to 130° C., greater than or equal to 110° C., greater than or equal to 90° C., greater than or equal to 70° C., or even greater than or equal to 50° C. below an annealing point of the lithium-free glass article. In embodiments, the hold temperature may be less than or equal to 20° C., less than or equal to 10° C., less than or equal to 5° C., or even less than or equal to 0° C. above an annealing point of the lithium-free glass article. In embodiments, the hold temperature may be greater than or equal to 130° C. below and less than or equal to 20° C. above, greater than or equal to 130° C. below and less than or equal to 10° C. above, greater than or equal to 130° C. below and less than or equal to 5° C. above, greater than or equal to 130° C. below and less than or equal to 0° C. above, greater than or equal to 110° C. below and less than or equal to 20° C. above, greater than or equal to 110° C. below and less than or equal to 10° C. above, greater than or equal to 110° C. below and less than or equal to 5° C. above, greater than or equal to 110° C. below and less than or equal to 0° C. above, greater than or equal to 90° C. below and less than or equal to 20° C. above, greater than or equal to 90° C. below and less than or equal to 10° C. above, greater than or equal to 90° C. below and less than or equal to 5° C. above, greater than or equal to 90° C. below and less than or equal to 0° C. above, greater than or equal to 70° C. below and less than or equal to 20° C. above, greater than or equal to 70° C. below and less than or equal to 10° C. above, greater than or equal to 70° C. below and less than or equal to 5° C. above, greater than or equal to 70° C. below and less than or equal to 0° C. above, greater than or equal to 50° C. below and less than or equal to 20° C. above, greater than or equal to 50° C. below and less than or equal to 10° C. above, greater than or equal to 50° C. below and less than or equal to 5° C. above, or even greater than or equal to 50° C. below and less than or equal to 0° C. above, or any and all sub-ranges formed from any of these endpoints, an annealing point of the lithium-free glass article

In embodiments, the hold temperature may be greater than or equal to 500° C. and less than or equal to 650° C. In embodiments, the hold temperature may be greater than or equal to 500° C., greater than or equal to 525° C., greater than or equal to 550° C., or even greater than or equal to 575° C. In embodiments, the hold temperature may be less than or equal to 650° C., less than or equal to 625° C., or even less than or equal to 600° C. In embodiments, the hold temperature may be greater than or equal to 500° C. and less than or equal to 650° C., greater than or equal to 500° C. and less than or equal to 625° C., greater than or equal to 500° C. and less than or equal to 600° C., greater than or equal to 525° C. and less than or equal to 650° C., greater than or equal to 525° C. and less than or equal to 625° C., greater than or equal to 525° C. and less than or equal to 600° C., greater than or equal to 550° C. and less than or equal to 650° C., greater than or equal to 550° C. and less than or equal to 625° C., greater than or equal to 550° C. and less than or equal to 600° C., greater than or equal to 575° C. and less than or equal to 650° C., greater than or equal to 575° C. and less than or equal to 625° C., or even greater than or equal to 575° C. and less than or equal to 600° C., or any and all sub-ranges formed from any of these endpoints.

In embodiments, the lithium-free glass article may be heated to the hold temperature at a heating rate greater than or equal to 3° C./min and less than or equal to 20° C./min to ensure efficiency while mitigating or eliminating the risk of breakage due to thermal shock. In embodiments, the heating rate may be greater than or equal to 3° C./min, greater than or equal to 5° C./min, greater than or equal to 7° C./min, or even greater than or equal to 10° C./min. In embodiments, heating rate may be less than or equal to 20° C./min, less than or equal to 17° C./min, less than or equal to 15° C./min, or even less than or equal to 15° C./min. In embodiments, the heating rate may be greater than or equal to 3° C./min and less than or equal to 20° C./min, greater than or equal to 3° C./min and less than or equal to 17° C./min, greater than or equal to 3° C./min and less than or equal to 15° C./min, greater than or equal to 3° C./min and less than or equal to 13° C./min, greater than or equal to 5° C./min and less than or equal to 20° C./min, greater than or equal to 5° C./min and less than or equal to 17° C./min, greater than or equal to 5° C./min and less than or equal to 15° C./min, greater than or equal to 5° C./min and less than or equal to 13° C./min, greater than or equal to 7° C./min and less than or equal to 20° C./min, greater than or equal to 7° C./min and less than or equal to 17° C./min, greater than or equal to 7° C./min and less than or equal to 15° C./min, greater than or equal to 7° C./min and less than or equal to 13° C./min, greater than or equal to 10° C./min and less than or equal to 20° C./min, greater than or equal to 10° C./min and less than or equal to 17° C./min, greater than or equal to 10° C./min and less than or equal to 15° C./min, or even greater than or equal to 10° C./min and less than or equal to 13° C./min, or any and all sub-ranges formed from any of these endpoints.

Referring again to FIG. 2, the thermal treatment profile further includes holding the lithium-free glass article at the hold temperature for a hold period (block 102b of FIG. 1). Relatively longer hold periods may impart a reduced fictive temperature, thereby achieving a desired compressive stress (e.g., greater than or equal to 900 MPa, as measured for an article having a thickness of 1.1 mm). Relatively longer hold periods may also impart a relatively greater warp to the resulting ion exchanged lithium-free glass article. As such, it may be desirable to limit the hold period to achieve a desired warp (e.g., a warp less than or equal to 0.3 mm, as measured for an article having a length less than 200 mm). In embodiments, the hold period may be dependent on hold temperature, with relatively longer hold periods corresponding with relatively low hold temperatures and vice versa.

In embodiments, the hold period may be greater than or equal to 0.05 hour and less than or equal to 24 hours. In embodiments, the hold period may be greater than or equal to 0.25 hour and less than or equal to 6 hours. In embodiments, the hold period may be greater than or equal to 0.05 hour, greater than or equal to 0.1 hour, greater than or equal to 0.25 hour, greater than or equal to 0.5 hour, greater than or equal to 1 hour, or even greater than or equal to 2 hours. In embodiments, the hold period may be less than or equal to 24 hours, less than or equal to 18 hours, less than or equal to 12 hours, less than or equal to 8 hours, less than or equal to 6 hours, or even less than or equal to 4 hours. In embodiments, the hold period may be greater than or equal to 0.05 hour and less than or equal to 24 hours, greater than or equal to 0.05 hour and less than or equal to 18 hours, greater than or equal to 0.05 hour and less than or equal to 12 hours, greater than or equal to 0.05 hour and less than or equal to 8 hours, greater than or equal to 0.05 hour and less than or equal to 6 hours, greater than or equal to 0.05 hour and less than or equal to 4 hours, greater than or equal to 0.1 hour and less than or equal to 24 hours, greater than or equal to 0.1 hour and less than or equal to 18 hours, greater than or equal to 0.1 hour and less than or equal to 12 hours, greater than or equal to 0.1 hour and less than or equal to 8 hours, greater than or equal to 0.1 hour and less than or equal to 6 hours, greater than or equal to 0.1 hour and less than or equal to 4 hours, greater than or equal to 0.25 hour and less than or equal to 24 hours, greater than or equal to 0.25 hour and less than or equal to 18 hours, greater than or equal to 0.25 hour and less than or equal to 12 hours, greater than or equal to 0.25 hour and less than or equal to 8 hours, greater than or equal to 0.25 hour and less than or equal to 6 hours, greater than or equal to 0.25 hour and less than or equal to 4 hours, greater than or equal to 0.5 hour and less than or equal to 24 hours, greater than or equal to 0.5 hour and less than or equal to 18 hours, greater than or equal to 0.5 hour and less than or equal to 12 hours, greater than or equal to 0.5 hour and less than or equal to 8 hours, greater than or equal to 0.5 hour and less than or equal to 6 hours, greater than or equal to 0.5 hour and less than or equal to 4 hours, greater than or equal to 1 hour and less than or equal to 24 hours, greater than or equal to 1 hour and less than or equal to 18 hours, greater than or equal to 1 hour and less than or equal to 12 hours, greater than or equal to 1 hour and less than or equal to 8 hours, greater than or equal to 1 hour and less than or equal to 6 hours, greater than or equal to 1 hour and less than or equal to 4 hours, greater than or equal to 2 hours and less than or equal to 24 hours, greater than or equal to 2 hours and less than or equal to 18 hours, greater than or equal to 2 hours and less than or equal to 12 hours, greater than or equal to 2 hours and less than or equal to 8 hours, greater than or equal to 2 hours and less than or equal to 6 hours, or even greater than or equal to 2 hours and less than or equal to 4 hours, or any and all sub-ranges formed from any of these endpoints.

Referring again to FIG. 2, the thermal treatment profile further includes cooling the lithium-free glass article at a first cooling rate from the hold temperature to an intermediate temperature (block 102c of FIG. 1). At temperatures above the intermediate temperature, the glass properties may change relatively quickly. At temperatures below an intermediate temperature, the glass properties may change relatively slowly. As such, the glass article may be subjected to relatively fast cooling rate at temperature below an intermediate temperature. Therefore, cooling at a relatively slower cooling rate (i.e., first cooling rate) to an intermediate temperature prior to cooling at a relatively faster cooling rate (i.e., second cooling rate) may help to achieve a reduced fictive temperature while reducing overall processing time.

In embodiments, the first cooling rate may be greater than or equal to 0.2° C./min and less than or equal to 4° C./min. In embodiments, the first cooling rate may be greater than or equal to 0.2° C./min, greater than or equal to 0.5° C./min, or even greater than or equal to 1° C./min. In embodiments, the first cooling rate may be less than or equal to 4° C./min, less than or equal to 3° C./min, or even less than or equal to 2° C./min. In embodiments, the first cooling rate may be greater than or equal to 0.2° C./min and less than or equal to 4° C./min, greater than or equal to 0.2° C./min and less than or equal to 3° C./min, greater than or equal to 0.2° C./min and less than or equal to 2° C./min, greater than or equal to 0.6° C./min and less than or equal to 4° C./min, greater than or equal to 0.6° C./min and less than or equal to 3° C./min, greater than or equal to 0.6° C./min and less than or equal to 2° C./min, greater than or equal to 1° C./min and less than or equal to 4° C./min, greater than or equal to 1° C./min and less than or equal to 3° C./min, or even greater than or equal to 1° C./min and less than or equal to 2° C./min, or any and all sub-ranges formed from any of these endpoints.

In embodiments, the intermediate temperature may be greater than or equal to 300° C. and less than or equal to 530° C. In embodiments, the intermediate temperature may greater than or equal to 300° C. greater than or equal to 340° C., greater than or equal to 380° C., greater than or equal to 420° C., greater than or equal to 460° C., or even greater than or equal to 500° C. In embodiments, the intermediate temperature may be less than or equal to 530° C., less than or equal to 500° C., less than or equal to 470° C., less than or equal to 440° C., or even less than or equal to 410° C. In embodiments, the intermediate temperature may be greater than or equal to 300° C. and less than or equal to 530° C., greater than or equal to 300° C. and less than or equal to 500° C., greater than or equal to 300° C. and less than or equal to 470° C., greater than or equal to 300° C. and less than or equal to 440° C., greater than or equal to 300° C. and less than or equal to 410° C., greater than or equal to 340° C. and less than or equal to 530° C., greater than or equal to 340° C. and less than or equal to 500° C., greater than or equal to 340° C. and less than or equal to 470° C., greater than or equal to 340° C. and less than or equal to 440° C., greater than or equal to 340° C. and less than or equal to 410° C., greater than or equal to 380° C. and less than or equal to 530° C., greater than or equal to 380° C. and less than or equal to 500° C., greater than or equal to 380° C. and less than or equal to 470° C., greater than or equal to 380° C. and less than or equal to 440° C., greater than or equal to 380° C. and less than or equal to 410° C., greater than or equal to 420° C. and less than or equal to 530° C., greater than or equal to 420° C. and less than or equal to 500° C., greater than or equal to 420° C. and less than or equal to 470° C., greater than or equal to 420° C. and less than or equal to 440° C., greater than or equal to 460° C. and less than or equal to 530° C., greater than or equal to 460° C. and less than or equal to 500° C., greater than or equal to 460° C. and less than or equal to 470° C., greater than or equal to 500° C. and less than or equal to 530° C., or any and all sub-ranges formed from any of these endpoints.

Referring back to FIG. 2, the thermal treatment profile further includes cooling the lithium-free glass article at a second cooling rate from the intermediate temperature to room temperature (block 102d of FIG. 1). The cooling may include cooling the lithium-free glass article at a second cooling rate greater than or equal to 20° C./min and less than or equal to 120° C./min to room temperature. Relatively faster cooling rates, in conjunction with relatively slower cooling rates may impart a reduced warp to the resulting ion exchanged lithium-free glass article (e.g., a warp less than or equal to 0.3 mm, as measured for an article having a length less than 200 mm) while reducing overall processing time.

In embodiments, the second cooling rate may be greater than or equal to 20° C./min and less than or equal to 120° C./min. In embodiments, the second cooling rate may be greater than or equal to 40° C./min and less than or equal to 100° C./min. In embodiments, the second cooling rate may be greater than or equal to 20° C./min, greater than or equal to 40° C./min, greater than or equal to 60° C./min, or even greater than or equal to 80° C./min. In embodiments, the first cooling rate may be less than or equal to 120° C./min or even less than or equal to 100° C./min. In embodiments, the second cooling rate may be greater than or equal to 20° C./min and less than or equal to 120° C./min, greater than or equal to 20° C./min and less than or equal to 100° C./min, greater than or equal to 40° C./min and less than or equal to 120° C./min, greater than or equal to 40° C./min and less than or equal to 100° C./min, greater than or equal to 60° C./min and less than or equal to 120° C./min, greater than or equal to 60° C./min and less than or equal to 100° C./min, greater than or equal to 80° C./min and less than or equal to 120° C./min, or even greater than or equal to 80° C./min and less than or equal to 100° C./min, or any and all sub-ranges formed from any of these endpoints.

Referring back to FIG. 1, the method 100 continues at block 104 with ion exchanging the thermally treated lithium-free glass article. As described herein, reducing the fictive temperature creates a shrinkage or compaction of the glass structure, thereby densifying the glass. When the densified glass is subjected to ion exchange, the glass exhibits a relatively low amount of stress relaxation, thereby improving the compressive stress (e.g., greater than or equal to 900 MPa, as measured for an article having a thickness of 1.1 mm) of the resulting ion exchanged glass. Additionally, compacting the glass article reduces the diffusion of ions into the glass article, thereby reducing the depth of layer with reduction of fictive temperature.

In typical ion exchange processes, smaller metal ions in the glass article are replaced or “exchanged” with larger metal ions of the same valence within a layer that is close to the outer surface of the glass article. The replacement of smaller ions with larger ions creates a compressive stress within the layer of the glass article. In embodiments, the metal ions are monovalent metal ions (e.g., Li⁺, Na⁺, K⁺, and the like), and ion exchange is accomplished by immersing the glass article in a bath comprising at least one molten salt of the larger metal ion that is to replace the smaller metal ion in the glass article. Alternatively, other monovalent ions such as Ag⁺, Tl⁺, Cu⁺, and the like may be exchanged for monovalent ions. The ion exchange process or processes that are used to strengthen the glass article may include, but are not limited to, immersion in a single bath or multiple baths of like or different compositions with washing and/or annealing steps between immersions.

Upon exposure to the glass article, the ion exchange bath (e.g., greater than or equal to 90 wt % and less than or equal to 100 wt % KNO₃ and greater than or equal to 0 wt % and less than or equal to 10 wt % NaNO₃) may, according to embodiments, be at a temperature that is less than the hold temperature of the thermal treatment. For example, in embodiments, the ion exchange bath may be at a temperature greater than or equal to about 380° C. and less than or equal to about 500° C. In embodiments, the ion exchange bath may be at a temperature greater than or equal to about 380° C., greater than or equal to about 400° C., or even temperature greater than or equal to about 420° C. In embodiments, the ion exchange bath may be at a temperature less than or equal to about 500° C. or even less than or equal to 450 C. In embodiments, the ion exchange bath may be at a temperature greater than or equal to about 380° C. and less than or equal to about 500° C., greater than or equal to about 380° C. and less than or equal to about 450° C., greater than or equal to about 400° C. and less than or equal to about 500° C., greater than or equal to about 400° C. and less than or equal to about 450° C., greater than or equal to about 420° C. and less than or equal to about 500° C., or even greater than or equal to about 420° C. and less than or equal to about 450° C., or any and all sub-ranges formed from any of these endpoints.

In embodiments, the thermally treated lithium-free glass article may be strengthened in the ion exchange bath for a time period greater than or equal to 1 hour and less than or equal to 20 hours. In embodiments, the ion exchange time period may be greater than or equal to 1 hour, greater than or equal to 2 hours, greater than or equal to 4 hours, greater than or equal to 8 hours, or even greater than or equal to 12 hours. In embodiments, the ion exchange time period may be less than or equal to 20 hours, less than or equal to 16 hours, less than or equal to 12 hours, less than or equal to 10 hours, less than or equal to 8 hours, less than or equal to 6 hours, or even less than or equal to 4 hours. In embodiments, the ion exchange time period may be greater than or equal to 1 hour and less than or equal to 20 hours, greater than or equal to 1 hour and less than or equal to 16 hours, greater than or equal to 1 hour and less than or equal to 12 hours, greater than or equal to 1 hour and less than or equal to 8 hours, greater than or equal to 1 hour and less than or equal to 6 hours, greater than or equal to 1 hour and less than or equal to 4 hours, greater than or equal to 2 hours and less than or equal to 20 hours, greater than or equal to 2 hours and less than or equal to 16 hours, greater than or equal to 2 hours and less than or equal to 12 hours, greater than or equal to 2 hours and less than or equal to 8 hours, greater than or equal to 2 hours and less than or equal to 6 hours, greater than or equal to 2 hours and less than or equal to 4 hours, greater than or equal to 4 hours and less than or equal to 20 hours, greater than or equal to 4 hours and less than or equal to 16 hours, greater than or equal to 4 hours and less than or equal to 12 hours, greater than or equal to 4 hours and less than or equal to 8 hours, greater than or equal to 4 hours and less than or equal to 6 hours, greater than or equal to 8 hours and less than or equal to 20 hours, greater than or equal to 8 hours and less than or equal to 16 hours, greater than or equal to 8 hours and less than or equal to 12 hours, greater than or equal to 12 hours and less than or equal to 20 hours, or even greater than or equal to 12 hours and less than or equal to 16 hours, or any and all sub-ranges formed from any of these endpoints.

In embodiments, the ion exchanged lithium-free glass article may comprise a compressive stress greater than or equal to 900 MPa, as measured for an article having a thickness of 1.1 mm. In embodiments, the ion exchanged lithium-free glass article may comprise a compressive stress greater than or equal to 1000 MPa, as measured for an article having a thickness of 1.1 mm. In embodiments, the ion exchanged lithium-free glass article may comprise a compressive stress greater than or equal to 900 MPa, greater than or equal to 950 MPa, greater than or equal to 1000 MPa, or even greater than or equal to 1150 MPa, as measured for an article having a thickness of 1.1 mm.

In embodiments, the ion exchanged lithium-free glass article may comprise a depth of layer greater than or equal to 35 μm, as measured for an article having a thickness of 1.1 mm. In embodiments, the ion exchanged lithium-free glass article may comprise a depth of layer greater than or equal to 35 μm, greater than or equal to 40 μm, greater than or equal to 45 μm, or even greater than or equal to 50 μm. In embodiments, the ion exchanged lithium-free glass article may comprise a depth of layer less than or equal to 90 μm, less than or equal to 80 μm, or even less than or equal to 70 μm. In embodiments, the ion exchanged lithium-free glass article may comprise a depth of layer greater than or equal to 35 μm and less than or equal to 90 μm, greater than or equal to 35 μm and less than or equal to 80 μm, greater than or equal to 35 μm and less than or equal to 70 μm, greater than or equal to 40 μm and less than or equal to 90 μm, greater than or equal to 40 μm and less than or equal to 80 μm, greater than or equal to 40 μm and less than or equal to 70 μm, greater than or equal to 45 μm and less than or equal to 90 μm, greater than or equal to 45 μm and less than or equal to 80 μm, greater than or equal to 45 μm and less than or equal to 70 μm, greater than or equal to 50 μm and less than or equal to 90 μm, greater than or equal to 50 μm and less than or equal to 80 μm, or even greater than or equal to 50 μm and less than or equal to 70 μm, or any and all sub-ranges formed from any of these endpoints.

In embodiments, the ion exchanged lithium-free glass article may comprise a warp less than or equal to 0.3 mm, as measured for an article having a length less than 200 mm. In embodiments, the ion exchanged lithium-free glass article may comprise a warp less than or equal to 0.2 mm, as measured for an article having a length less than 200 mm. In embodiments, the ion exchanged lithium-free glass article may comprise a warp less than or equal to 0.3 mm, less than or equal to 0.2 mm, or even less than or equal to 0.1 mm, as measured for an article having a length less than 200 mm.

In embodiments, the ion exchanged lithium-free glass article may comprise an anti-glare texture (e.g., via chemical etching) thereon.

In embodiments in which the ion exchanged lithium-free glass article does not comprise an anti-glare texture, the ion exchanged lithium-free glass article may comprise a warp, as measured for an article having a length less than 200 mm, less than or equal to 0.2 mm or even less than or equal to 0.1 mm. In embodiments in which the ion exchanged lithium-free glass article does not comprise an anti-glare texture, the ion exchanged lithium-free glass article may comprise a warp, as measured for an article having a length greater than or equal to 200 mm and less than 300 mm, less than or equal to 0.2 mm or even less than or equal to 0.1 mm. In embodiments in which the ion exchanged lithium-free glass article does not comprise an anti-glare texture, the ion exchanged lithium-free glass article may comprise a warp, as measured for an article having a length greater than or equal to 300 mm and less than 900 mm, less than or equal to 0.3 mm, less than or equal to 0.2 mm or even less than or equal to 0.1 mm.

In embodiments in which the ion exchanged lithium-free glass article comprises an anti-glare texture, the ion exchanged lithium-free glass article may comprise a warp, as measured for an article having a length less than 200 mm, less than or equal to 0.3 mm, less than or equal to 0.2 mm or even less than or equal to 0.1 mm. In embodiments in which the ion exchanged lithium-free glass article comprises an anti-glare texture, the ion exchanged lithium-free glass article may comprise a warp, as measured for an article having a length greater than or equal to 200 mm and less than 300 mm, less than or equal to 0.7 mm, less than or equal to 0.5 mm, less than or equal to 0.3 mm or even less than or equal to 0.1 mm. In embodiments in which the ion exchanged lithium-free glass article comprises an anti-glare texture, the ion exchanged lithium-free glass article may comprise a warp, as measured for an article having a length greater than or equal to 300 mm and less than 900 mm, less than or equal to 0.8 mm, less than or equal to 0.6 mm, less than or equal to 4 mm, or even less than or equal to 0.2 mm.

Other properties of the lithium-free glass article or parameters of thermal treatment may impart a reduced warp. For example, the shape of the lithium-free glass article, such as round corners, may impart a reduced warp. Moreover, tilting the lithium-free glass article during thermal treatment may undesirably increase warp. Furthermore, the thermal treatment may comprise holding the lithium-free glass article in a cassette during thermal treatment. Moreover, the cassette itself may be modified, such as with additional side bars, to mitigate sagging of the lithium-free glass article, thereby reducing warp.

The ion exchanged lithium-free glass articles described herein may comprise an automotive interior article, such as windshields, as a cover lens material for modules in dashboard, instrument panels, cockpits, central instrument display, or heads up display (HUD), rear seat entertainment systems (RSEs). The ion exchanged lithium-free glass articles described herein may also be used in other applications such as, but not limited to, touch screens; protective cover glass for electronic devices such as a hand held communication or entertainment devices, information-related to terminals, or touch sensor devices; appliance enclosures, or architectural elements such as windows or panels.

### EXAMPLES

In order that various embodiments be more readily understood, reference is made to the following examples, which are intended to illustrate various embodiments of methods of forming a lithium-free glass article as described herein.

Generally, the examples provided herein exemplify how given thermal treatment and ion exchange parameters effect the resulting compressive stress and warp of the ion exchanged lithium-free glass article.

The composition (in wt %) of glass composition G1 used in the examples is shown in Table 1. The annealing point of glass composition G1 was 628° C.

TABLE 1

| | G1 |
|---|---|
| SiO₂ | 61.85 |
| B₂O₃ | 3.9 |
| Al₂O₃ | 18.68 |
| Na₂O | 12.91 |
| MgO | 1.43 |
| SnO₂ | 0.22 |

### Thermal Treatment-Fictive Temperature Modeling

Sample Articles S1-S7 having a thickness of 1.1 mm, a length of 50 mm, and a width of 50 mm were formed using glass composition G1. Sample Article S1 was not subjected to thermal treatment. Sample Articles S2-S7 were subjected to thermal treatment including heating to the hold temperatures listed in Table 2 at a heating rate of 10° C./min, holding at the hold temperature for the hold periods listed in Table 2, cooling to an intermediate temperature of 520° C. at a first cooling rate of 2° C./min, and cooling to room temperature at a second cooling rate of 100° C./min. Sample Article S1 and thermally treated Sample Articles S2-S7 were then subjected to the same ion exchange conditions. The fictive temperatures T_{f} of the samples, before and after ion exchange, are shown in Table 2.

TABLE 2

| | | | T_{f} before ion | T_{f} after ion |
|---|---|---|---|---|
| Sample | Hold temperature | Hold period | exchange | exchange |
| Article | (° C.) | (hr) | (° C.) | (° C.) |
| S1 | — | — | 684.7 | 677.4 |
| S2 | 520 | 4 | 632.4 | 623.7 |
| S3 | 550 | 24 | 574.0 | 558.4 |
| S4 | 550 | 4 | 607.5 | 598.2 |
| S5 | 570 | 4 | 578.3 | 590.8 |
| S6 | 570 | 1 | 615.8 | 614.4 |
| S7 | 600 | 1 | 599.2 | 599.6 |

As shown in Table 2, the fictive temperatures of the sample articles before and after ion exchange were highly correlated. As exemplified by Table 2, the fictive temperature of an article after ion exchange may be measured to trace the fictive temperature and know what thermal treatment process the article was subjected to.

Referring now to FIG. 3, a fictive temperature calculation model was developed to predict the fictive temperature resulting from a given thermal treatment. Model parameters were calibrated by matching the model predicted fictive temperatures with the fictive temperatures measured before ion exchange listed in Table 2.

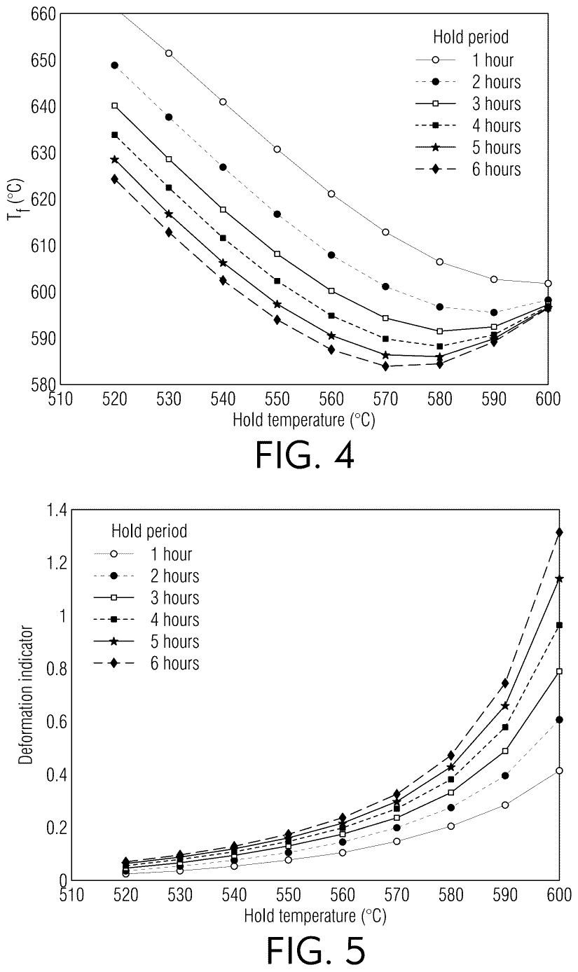

Referring now to FIG. 4, the fictive temperature calculation model was used to predict the fictive temperature resulting from the thermal treatments indicated in FIG. 4. As shown in FIG. 4, the fictive temperature initially reduced with greater hold temperatures, reached a minimum, and then started to increase with even greater hold temperatures. As exemplified by FIG. 4, longer hold periods correspond with lower fictive temperatures.

While not wishing to be bound by theory, it is believed warp may be induced by the viscous deformation (i.e., creep) in the thermal treatment process with the application of mechanical and/or gravity force that the glass article experiences in the fixture. As sag=x

$${\int }_{0}^{t} \frac{1}{η} d t ,$$

the following formula for deformation indicator was used to quantify the warp resulting from a given thermal treatment process.

$$deformation indicator = {η}_{r e f} {\int }_{0}^{t} \frac{1}{η} d t$$

where η is the non-equilibrium viscosity calculated by the model and η_{ref} is a constant selected to scale the deformation indicator value to a reasonable number.

Referring now to FIG. 5, the fictive temperature calculation model was used to predict the deformation indicator resulting from the thermal treatments indicated in FIG. 5. As exemplified by FIG. 5, greater hold temperatures and longer hold periods correspond with larger deformation.

### Ion Exchange Examples

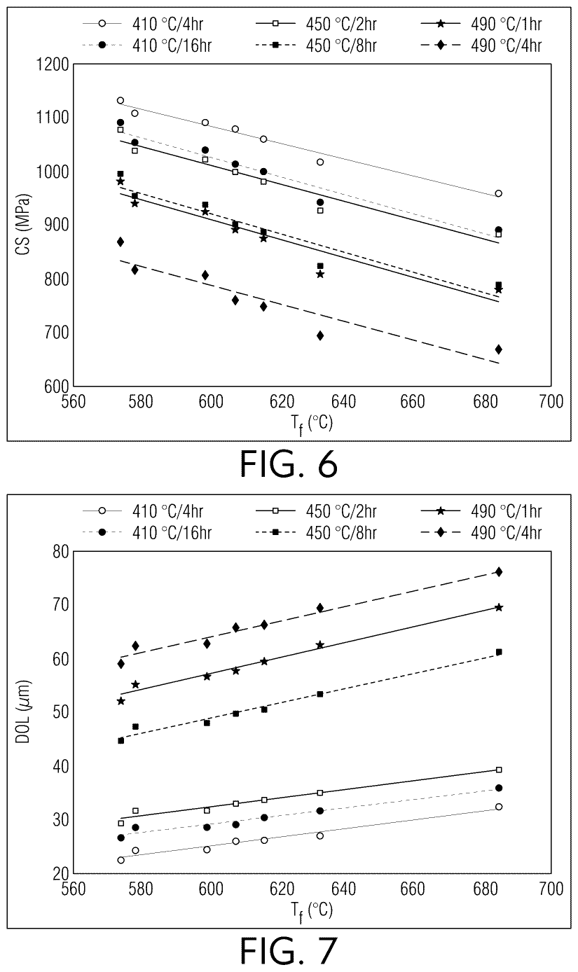

Referring now to FIGS. 6 and 7, sample glass articles formed from glass composition G1 having a thickness of 1.1 mm, a length of 50 mm, and a width of 50 mm were subjected to an ion exchange bath of 100 wt % KNO₃ with a 0.5 wt % super addition of silicic acid at the temperature and for the time period indicated in FIGS. 6 and 7. The correlation between fictive temperature and compressive stress CS and depth of layer DOL after being subjected to the given ion exchange conditions are shown in FIGS. 6 and 7. As exemplified in FIG. 6, reducing the fictive temperature, which leads to compacting of the glass article, results in greater compressive stress. As exemplified in FIG. 7, compacting the glass article reduces the diffusion of ions into the glass article, thereby reducing the depth of layer with reduction of fictive temperature.

### Warp Examples

### Hold Temperature and Hold Period

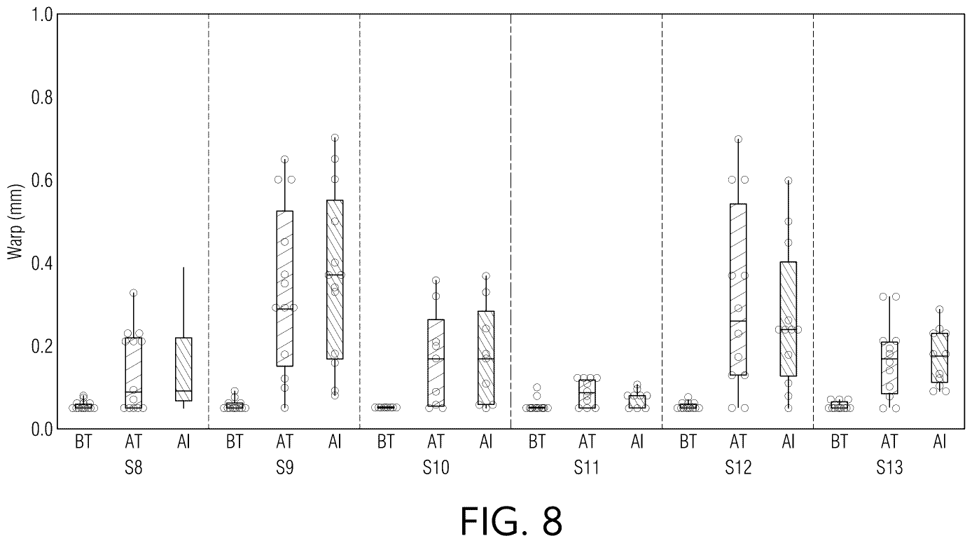

Referring now to FIG. 8, Sample Articles S8-S13 having a thickness of 1.1 mm, a length of 622 mm, and a width of 121 mm were formed using glass composition G1. Sample Articles S11-S13 further included an anti-glare texture (e.g., via chemical etching) thereon. Sample Articles S8-S13 were subjected to thermal treatment including heating to a hold temperature at a heating rate of 5° C./min, holding at the hold temperature for a hold period, cooling at a first cooling rate of 3° C./min from the hold temperature to an intermediate temperature of 380° C., and opening the furnace door (i.e., cooling from the intermediate temperature to room temperature at a second cooling rate greater than or equal to 20° C./min and less than or equal to 120° C./min). Sample Articles S8 and S11 were subjected to a hold temperature of 580° C. for a hold period of 40 minutes. Sample Articles S9 and S12 were subjected to a hold temperature of 600° C. for a hold period of 40 minutes. Sample Articles S10 and S13 were subjected to a hold temperature of 600° C. for a hold period of 15 minutes. After thermal treatment, the Sample Articles S8-S13 were subjected to ion exchange in an ion exchange bath including 92.5 wt % KNO₃ and 7.5 wt % K₂CO₃ with a 0.5 wt % super addition of silicic acid at 443° C. for 4 hours. The warp of Sample Articles S8-S13 before thermal treatment BT, after thermal treatment AT, and after ion exchange AI is shown in FIG. 8.

As shown in FIG. 8, Sample Articles S8 and S11, articles thermally treated at a hold temperature of 580° C. for a hold period of 40 minutes, had lower warp than Sample Articles S9 and S12, respectively, articles thermally treated at hold temperature of 600° C. for a hold period of 40 minutes. As exemplified by FIG. 8, warp is increased by greater hold temperatures when hold period is kept constant.

As also shown in FIG. 8, Sample Articles S9 and S12, articles thermally treated at hold temperature of 600° C. for a hold period of 40 minutes, had a higher warp than Sample Articles S10 and S13, respectively, articles thermally treated at hold temperature of 600° C. for a hold period of 15 minutes. As exemplified by FIG. 8, warp is increased by greater hold periods when hold temperature is kept constant.

### Cooling Rate

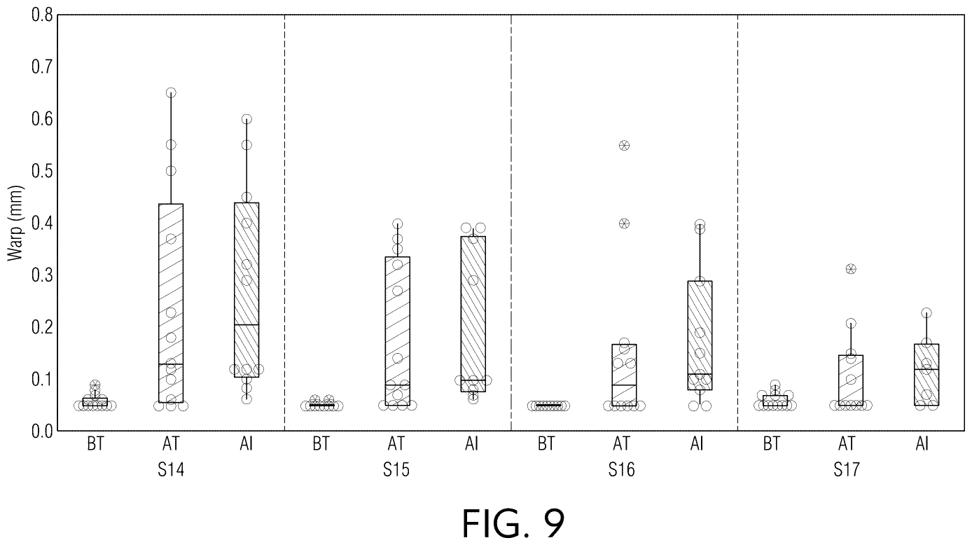

Referring now to FIG. 9, Sample Articles S14-S17 having a thickness of 1.1 mm, a length of 622 mm, and a width of 121 mm were formed using glass composition G1. Sample Articles S16 and S17 further included an anti-glare texture thereon. Sample Articles S14- and S16 were subjected to thermal treatment including heating to a hold temperature of 570° C. at a heating rate of 5° C./min, holding at the hold temperature for a hold period of 3 hours, cooling at a first cooling rate of 3° C./min from the hold temperature to an intermediate temperature of 520° C., and opening the furnace door (i.e., cooling at a second cooling rate greater than or equal to 20° C./min and less than or equal to 120° C./min from the intermediate temperature to room temperature). Sample Articles S15 and S17 were subjected to thermal treatment including heating to a hold temperature of 570° C. at a heating rate of 5° C./min, holding at the hold temperature for a hold period of 3 hours, cooling at a first cooling rate of 3° C./min from the hold temperature to an intermediate temperature of 360° C., and opening the furnace door (i.e., cooling at a second cooling rate greater than or equal to 20° C./min and less than or equal to 120° C./min from the intermediate temperature to room temperature). After thermal treatment, the Sample Articles S14-S17 were subjected to ion exchange in an ion exchange bath including 92.5 wt % KNO₃ and 7.5 wt % K₂CO₃ with a 0.5 wt % super addition of silicic acid at 443° C. for 4 hours. The warp of Sample Articles S14-S17 before thermal treatment BT, after thermal treatment AT, and after ion exchange AI is shown in FIG. 9.

As shown in FIG. 9, Sample Articles S15 and S17, articles thermally treated at a first cooling rate to an intermediate temperature of 360° C., had lower warp than Sample Articles S14 and S16, respectively, articles thermally treated at a first cooling rate to an intermediate temperature of 520° C. As exemplified by FIG. 9, warp may be reduced by cooling to a given intermediate temperature at a relatively slow cooling rate before cooling to room temperature at a relatively fast cooling rate.

### Part Shape

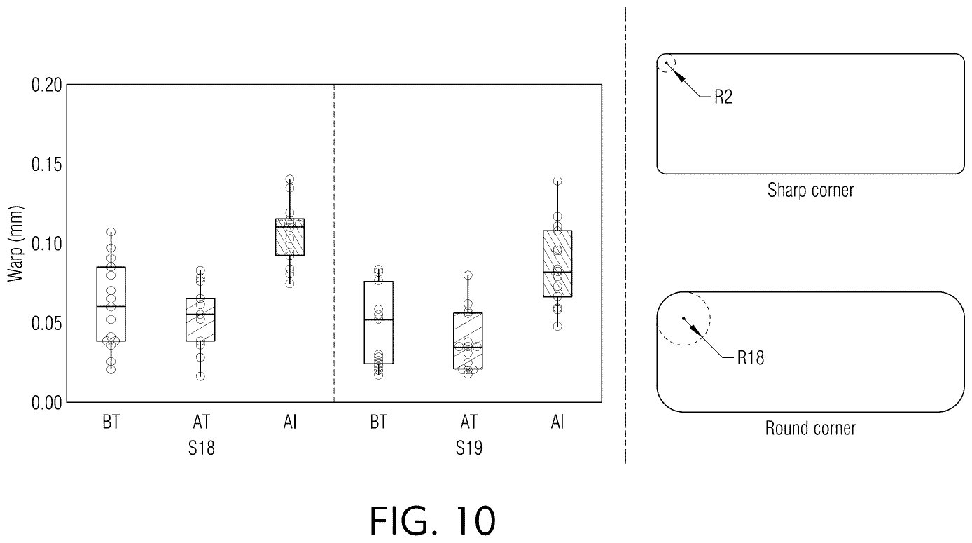

Referring now to FIG. 10, Sample Articles S18 and S19 having a thickness of 1.1 mm and length of 121 mm were formed using glass composition G1. Sample Article S18 included sharp corners as shown in FIG. 10. Sample Article S19 included round corners as shown in FIG. 10. Sample Articles S18 and S19 were subjected to thermal treatment including heating to a hold temperature of 580° C. at a heating rate of 10° C./min, holding at the hold temperature for a hold period of 1 hour, cooling from the hold temperature to an intermediate temperature of 380° C. at a first cooling rate of 3° C./min, and opening the furnace door (i.e., cooling at a second cooling rate greater than or equal to 20° C./min and less than or equal to 120° C./min from the intermediate temperature to room temperature). After thermal treatment, Sample Articles S18 and S19 were subjected to ion exchange in an ion exchange bath including 92.5 wt % KNO₃ and 7.5 wt % K₂CO₃ with a 0.5 wt % super addition of silicic acid at 460° C. for 4 hours. The warp of Sample Articles A14-A17 before thermal treatment BT, after thermal treatment AT, and after ion exchange AI is shown in FIG. 10.

As shown in FIG. 10, Sample Article S19, an article having round corners, had a lower warp than Sample Article S18, an article having sharp corners. As exemplified by FIG. 10, corner radii of the glass article may effect warp.

### Tilting

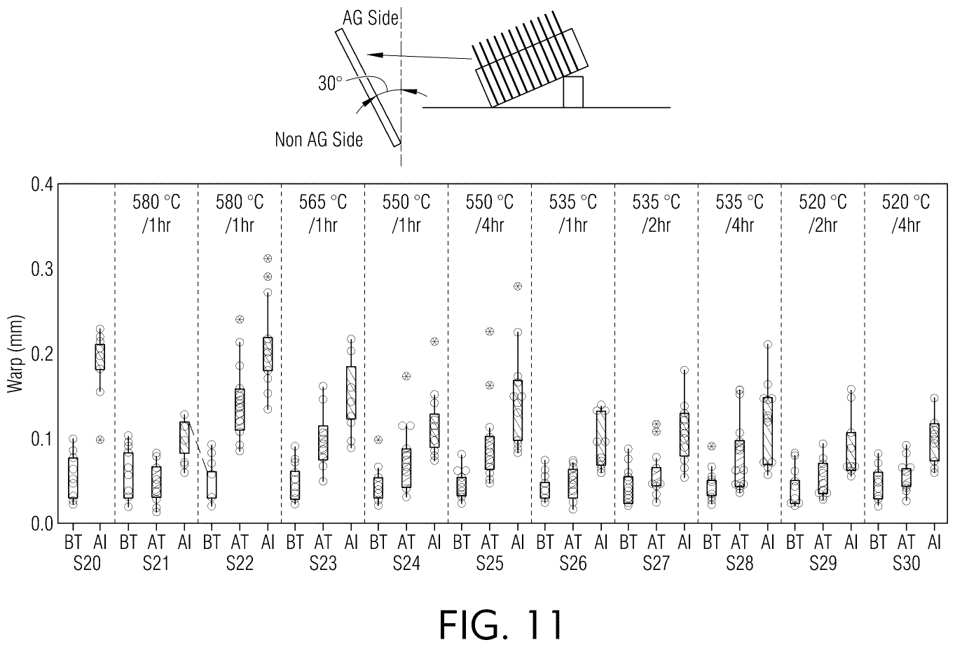

Referring now to FIG. 11, Sample Articles S20-S30 having a thickness of 1.1 mm and length of 121 mm were formed using glass composition G1. Sample Article S20 was not subjected to any thermal treatment. Sample Articles S21-S30 were subjected to thermal treatment including heating to the hold temperature indicated in FIG. 11 at a heating rate of 10° C./min, holding at the hold temperature for the hold period indicated in FIG. 11, cooling from the hold temperature to an intermediate temperature of 380° C. at a first cooling rate of 2° C./min, and opening the furnace door (i.e., cooling at a second cooling rate greater than or equal to 20° C./min and less than or equal to 120° C./min from the intermediate temperature to room temperature). During thermal treatment, Sample Articles S20 and S22-S30 were tilted 30°. Sample Article S20 and thermally treated Sample Articles S21-S30 were subjected to ion exchange in an ion exchange bath including 92.5 wt % KNO₃ and 7.5 wt % K₂CO₃ with a 0.5 wt % super addition of silicic acid at 460° C. for 4 hours. The warp of Sample Articles A14-A17 before thermal treatment BT, after thermal treatment AT, and after ion exchange AI is shown in FIG. 11.

As shown in FIG. 11, Sample Article S21, an article not tilted during thermal treatment at a hold temperature of 580° C. for a hold period of 1 hour, had a lower warp than Sample Article S22, an article tilted during thermal treatment at a hold temperature of 580° C. for a hold period of 1 hour. As exemplified by FIG. 11, warp increases if the glass article is tilted during the same thermal treatment conditions.

As also exemplified in FIG. 11, specifically Sample Articles S22-S30, as the hold temperature decreases, the warp imparted to the tilted glass articles decreases.

### Cassette

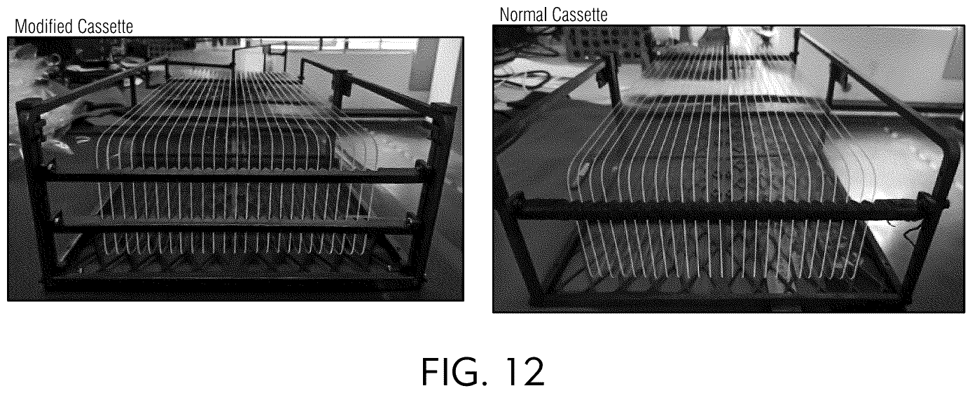

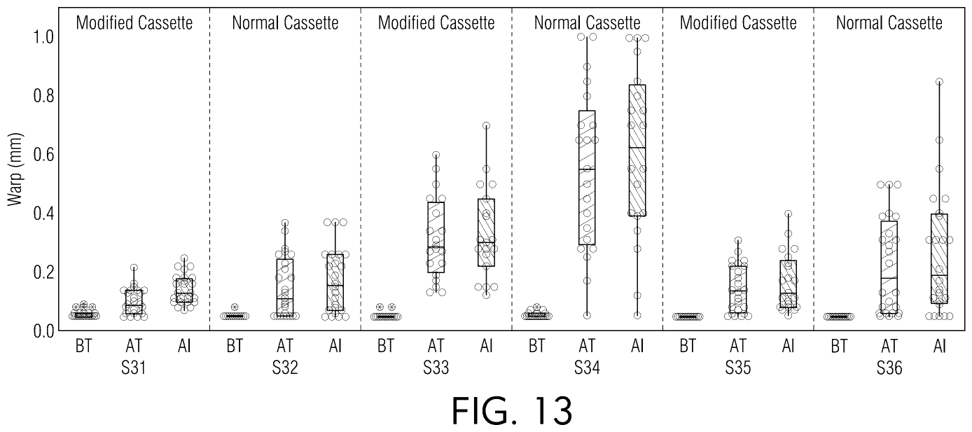

Referring now to FIGS. 12 and 13, Sample Articles S31-S34 having a thickness of 1.1 mm and length of 121 mm were formed using glass composition G1. Sample Articles S35 and S36 having a thickness of 0.7 mm and length of 121 mm were formed using glass composition G1. Sample Articles S32, S34, and S36 were held in a normal cassette as shown in FIG. 12 during thermal treatment. Sample Articles S31, S33, and S35 were held in a modified cassette having an additional side bar as shown in FIG. 12 during thermal treatment. Sample Articles S31-S36 were subjected to thermal treatment including heating to a hold temperature at a heating rate of 5° C./min, holding at the hold temperature for a hold period of 1 hour, cooling from the hold temperature to an intermediate temperature of 380° C. at a first cooling rate of 3° C./min, and opening the furnace door (i.e., cooling at a second cooling rate greater than or equal to 20° C./min and less than or equal to 120° C./min from the intermediate temperature to room temperature). Sample Articles S31, S32, S35 and S36 were subjected to a hold temperature of 570° C. Sample Articles S33 and S34 were subjected to a hold temperature of 600° C. After thermal treatment, Sample Articles S31-S36 were subjected to ion exchange in an ion exchange bath including 92.5 wt % KNO₃ and 7.5 wt % K₂CO₃ with a 0.5 wt % super addition of silicic acid at 443° C. for 4 hours. The warp of Sample Articles S31-S36 before thermal treatment BT, after thermal treatment AT, and after ion exchange AI is shown in FIG. 13.

As shown in FIG. 13, Sample Articles S31, S33, and S35, glass articles held in a modified cassette during thermal treatment, had a lower warp than Sample Articles S32, S34, and S35, respectively, glass articles held in a normal cassette during thermal treatment. As exemplified by FIG. 13, cassettes holding the glass articles during thermal treatment may effect warp.

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A method of forming a lithium-free glass article, the method comprising:
thermally treating the lithium-free glass article to impart a fictive temperature, the thermal treatment comprising:
heating the lithium-free glass article to a hold temperature greater than or equal to 130° C. below and less than or equal to 20° C. above an annealing point of the lithium-free glass article;
holding the lithium-free glass article at the hold temperature for a hold period; and
cooling the lithium-free glass article at a first cooling rate from the hold temperature to an intermediate temperature;
cooling the lithium-free glass article at a second cooling rate from the intermediate temperature to room temperature; and
ion exchanging the thermally treated lithium-free glass article,
wherein the ion exchanged lithium-free glass article comprises:
a compressive stress greater than or equal to 900 MPa, as measured for an article having a thickness of 1.1 mm; and
a warp less than or equal to 0.3 mm, as measured for an article having a length less than 200 mm.

2. The method of claim 1, wherein the fictive temperature is greater than or equal to 550° C. and less than or equal to 700° C.

3. The method of claim 1, wherein the hold period is greater than or equal to 0.05 minutes and less than or equal to 24 hours.

4. The method of claim 3, wherein the hold period is greater than or equal to 0.25 minutes and less than or equal to 6 hours.

5. The method of claim 1, wherein the lithium-free glass article is heated to the hold temperature at a heating rate greater than or equal to 3° C./min and less than or equal to 20° C./min.

6. The method of claim 1, wherein the hold temperature is greater than or equal to 110° C. below and less than or equal to 5° C. above an annealing point of the lithium-free glass article.

7. The method of claim 1, wherein the hold temperature is greater than or equal to 500° C. and less than or equal to 650° C.

8. The method of claim 1, wherein the first cooling rate is greater than or equal to 0.2° C./min and less than or equal to 4° C./min.

9. The method of claim 1, wherein the intermediate temperature is greater than or equal to 300° C. and less than or equal to 530° C.

10. The method of claim 1, wherein the second cooling rate is greater than or equal to 20° C./min and less than or equal to 120° C./min.

11. The method of claim 1, wherein the ion exchanging the thermally treated lithium-free glass article comprises strengthening the thermally treated lithium-free glass article in an ion exchange bath at a temperature greater than or equal to 380° C. and less than or equal to 500° C. for a time period greater than or equal to 1 hour and less than or equal to 20 hours.

12. The method of claim 11, wherein the ion exchange bath comprises greater than or equal to 90 wt % and less than or equal to 100 wt % KNO₃ and greater than or equal to 0 wt % and less than or equal to 10 wt % NaNO₃.

13. The method of claim 1, wherein the ion exchanged lithium-free glass article comprises a compressive stress greater than or equal to 1000 MPa, as measured for an article having a thickness of 1.1 mm.

14. The method of claim 1, wherein the ion exchanged lithium-free glass article comprises a warp less than or equal to 0.2 mm, as measured for an article having a length less than 200 mm.

15. The method of claim 1, wherein the ion exchanged lithium-free glass article comprises a depth of layer greater than or equal to 35 μm, as measured for an article having a thickness of 1.1 mm.

16. The method of claim 1, wherein the ion exchanged lithium-free glass article comprises an automotive interior article.

17. The method of claim 1, wherein the lithium-free glass article comprises an alkali aluminosilicate glass or an alkali aluminoborosilicate glass.

18. The method of claim 1, wherein the lithium-free glass article comprises:
greater than or equal to 50 wt % and less than or equal to 70 wt % SiO₂;
greater than or equal to 0 wt % and less than or equal to 10 wt % B₂O₃;
greater than or equal to 10 wt % and less than or equal to 30 wt % Al₂O₃;
greater than or equal to 2 wt % and less than or equal to 20 wt % Na₂O;
greater than or equal to 0 wt % and less than or equal to 1 wt % SnO₂; and
greater than or equal to 0 wt % and less than or equal to 5 wt % MgO.

19. The method of claim 1, wherein the lithium-free glass article comprises a thickness greater than or equal to 0.2 mm and less than or equal to 2 mm.

20. The method of claim 1, wherein the thermally treating the lithium-free glass article comprises holding the lithium-free glass article in a cassette during thermal treatment.
